(19) United States
(12) Patent Application Publication
(10) Pub. No.: US 2026/0338314 A1
(43) Pub. Date: Oct. 29, 2026

(54) MOUNTING BRACKET FOR VIDEO WALL

(71) Applicant: IWORKHUB LIMITED, Hong Kong (CN)

(72) Inventors: Hao XU, Hong Kong (CN); Lei SUN, Hong Kong (CN)

(73) Assignee: IWORKHUB LIMITED, Hong Kong (CN)

(21) Appl. No.: 19/234,970

(22) Filed: Jun. 11, 2025

(30) Foreign Application Priority Data
Apr. 28, 2025 (CN) 202520831725.9

(51) Int. Cl. F16M 11/04; F16M 11/20; G09F 9/302

(52) U.S. Cl. CPC F16M 11/041; F16M 11/2014; G09F 9/3026

(57) ABSTRACT

The present disclosure provides a mounting bracket for video wall. The mounting bracket includes at least one first mounting member and a plurality of hanging members. Each first mounting member extends horizontally and defines a clamping groove. The hanging member includes a hanging rod and a locking hook. The hanging rod is configured for connecting to a display cabinet of a video wall and suspending the display cabinet to the first mounting member. The locking lock is connected to the hanging rod. When the locking hook is engaged with the clamping groove, the hanging member is located in a locked state. When the locking hook is disengaged from the clamping groove, the hanging member is in an unlocked state. In this application, the locking hook of the hanging member securely engages with the clamping groove on the first mounting member, providing reliable fixation and facilitating rapid assembly/disassembly.

### CROSS-REFERENCE TO RELATED APPLICATIONS

The present application claims priority under 35 U.S.C. § 119(a) to Chinese Application Patent Application No. 202520831725.9, filed on Apr. 28, 2025, the entire disclosure of which is hereby incorporated by reference.

### TECHNICAL FIELD

The present disclosure relates to technical fields of display device mounting, and in particular relates to a mounting bracket for video wall.

### BACKGROUND

Technique of video wall is a technique that combines multiple display units (such as LCD panels, LED screens, etc.) to form a large-scale display system. Technique of video wall is widely used in command and control centers, advertising displays, conference systems, and other applications. Currently, the video wall mainly may be LCD video walls and LED video walls. Most wall-mounted video walls use sleeve-type mounting brackets, where the mounting bracket consists of horizontal bar and hanging members, and the hanging members which are used for hanging the display unit are sleeved onto the horizontal bar, making the mounting and disassembly process cumbersome.

### SUMMARY

In view of this, the present disclosure provides a mounting bracket for a video wall, to solve the above technical problems.

The present disclosure provides a mounting bracket for video wall. The mounting bracket can include at least one first mounting member and a plurality of hanging members. Each of the first mounting member extends horizontally and defines a clamping groove. Each of the hanging member includes a hanging rod and a locking hook. The hanging rod is configured for connecting to a display cabinet of a video wall and suspending the display cabinet to the corresponding first mounting member, and the locking hook is connected to the hanging rod. When the locking hook is engaged with the clamping groove, the hanging member is located in a locked state; when the locking hook is disengaged from the clamping groove, the hanging member is in an unlocked state.

Therefore, in the present disclosure, the display cabinet is suspended onto the first mounting member via the hanging rod and securely locked through the engagement between the locking hook and the clamping groove, achieving quick mounting, easy disassembly, and maintenance.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skill in the art may also obtain other drawings based on these drawings without any creative efforts.

FIG. 1 is a perspective view of a mounting bracket for video wall according to embodiments of the present disclosure;

FIG. 2 is a perspective view of a mounting bracket for hanging the video wall according to embodiments of the present disclosure;

FIG. 3 is an exploded and enlarged view of A of FIG. 1;

FIG. 4 is an enlarged view of B of FIG. 3;

FIG. 5 is a schematic view of a mounting state of a hanging member and a first mounting member;

FIG. 6 is an enlarged front view of B in FIG. 1;

FIG. 7 is a top view of FIG. 6;

FIG. 8 is an exploded view of FIG. 6;

FIG. 9 is a front view of a second mounting member and a third adjustment member;

FIG. 10 is a top view of FIG. 9;

FIG. 11 is an exploded view of FIG. 10;

FIG. 12 is a schematic view of the mounting bracket installed on a wooden column wall;

FIG. 13 is a schematic view of the mounting bracket installed on a concrete wall;

FIG. 14 is an extended schematic view of the hanging member.

### DETAILED DESCRIPTION OF ILLUSTRATED EMBODIMENTS

Embodiments of the present disclosure are described in detail below. Examples of the embodiments are shown in the accompanying drawings. The same or similar labeling throughout denotes the same or similar elements or elements having the same or similar functions. The embodiments described below by reference to the accompanying drawings are exemplary and are intended to be configured to explain the present disclosure and are not to be construed as limiting the present disclosure.

Furthermore, the terms “first” and “second” are used for descriptive purposes only and are not to be understood as indicating or implying relative importance or implicitly specifying the number of technical features indicated. Therefore, a feature defined with “first” or “second” may include one or more such features, either explicitly or implicitly. In the description of the present disclosure, “more than one” means two or more, unless otherwise expressly and specifically limited.

In the present disclosure, unless otherwise expressly specified and limited, the terms “connected”, “fixed”, and so on are to be understood broadly, e.g., they may be fixedly connected, removably connected, or integrally connected; they may be mechanically connected or electrically connected; they may be directly connected or indirectly connected through an intermediate medium; they may be interconnected within two elements or an interactive relationship between two elements. For those of ordinary skill in the art, the specific meaning of the above terms in the present disclosure may be understood on a case-by-case basis.

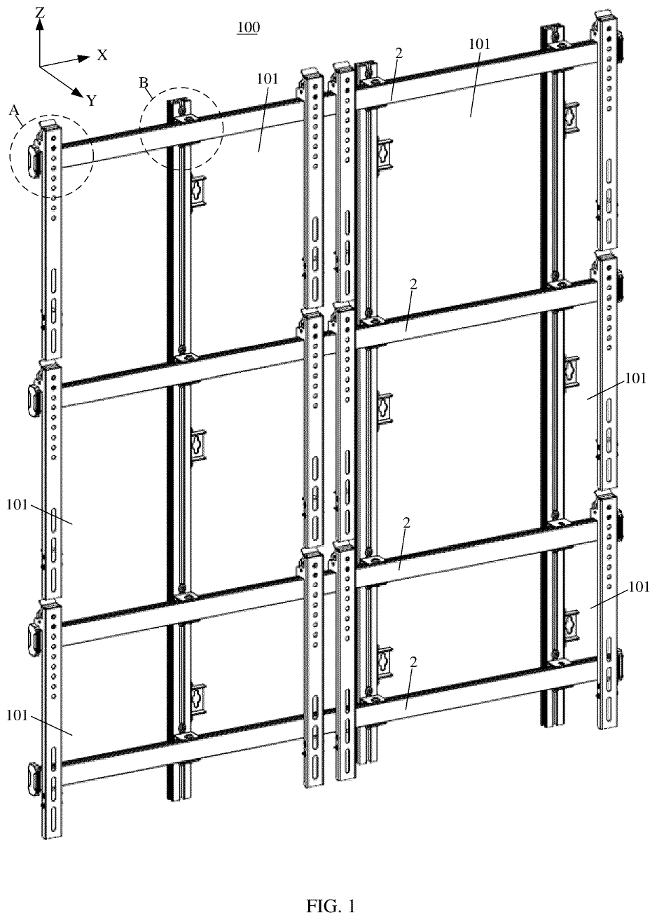

Please refer to FIG. 1. FIG. 1 is a perspective view of a mounting bracket 100 for video wall according to embodiments of the present disclosure. For ease of description, a front-rear direction of the mounting bracket 100 shown in FIG. 1 is defined as a Y-axis direction (i.e., the thickness direction), a left-right direction of the mounting bracket 100 shown in FIG. 1 is defined as a X-axis direction (i.e., the length direction), and a height direction of the mounting bracket 100 shown in FIG. 1 is defined as a Z-axis direction. The directional terms such as “top,” “bottom,” “left,” and “right” used in the description of the mounting bracket 100 in the embodiments of the present disclosure are based on the orientation shown in FIG. 1 of the specification drawings, where the positive Z-axis direction is “top,” the negative Z-axis direction is “bottom,” the negative X-axis direction is “left,” the positive X-axis direction is “right,” the negative Y-axis direction is “rear,” and the positive Y-axis direction is “front.” These terms do not limit the actual application scenarios of the mounting bracket 100. In this embodiment, the display device is a television. In other embodiments, the display device may also be a monitor or other device with a display screen, which is not limited herein.

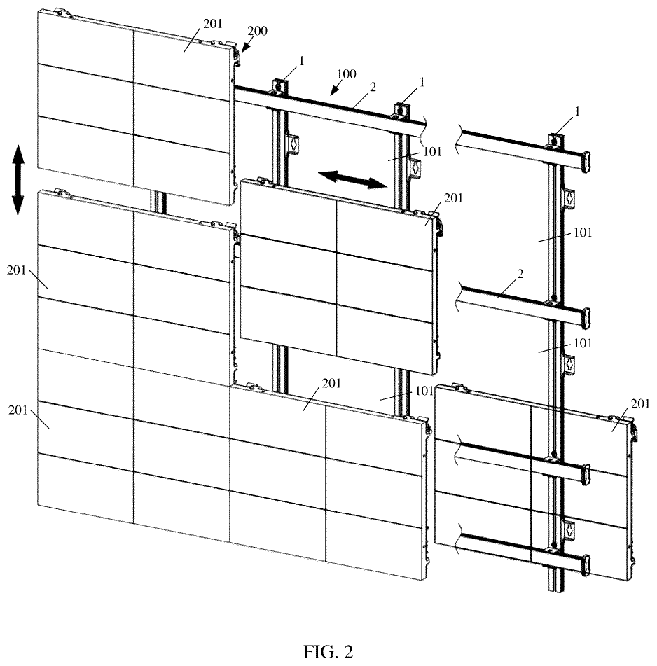

Please refer to FIG. 2. FIG. 2 is a perspective view of a mounting bracket 100 for hanging a video wall 200 according to embodiments of the present disclosure. The video wall 200 can include a plurality of display cabinets 201. The video wall 200 has a large-sized display area. Each display cabinet 201 has a small-sized display area. The small-sized display areas of the plurality of display cabinets 201 can be combined to form the large-sized display area of the video wall 200. It should be understood that the terms “large-sized” and “small-sized” here are relative concepts. The mounting bracket 100 can include a plurality of mounting sub-regions 101. Each mounting sub-region 101 is configured to mount one display cabinet 201. When the plurality of display cabinets 201 are respectively mounted on the plurality of mounting sub-regions 101 and adjacent display cabinets 201 abut against each other, the plurality of display cabinets 201 combine to form the large-sized display area of the video wall 200. The video wall 200 can be configured to display content as a whole or in partitioned sections.

In at least one embodiment, the video wall 200 may be an LED display screen, an LCD display screen, etc. Each display cabinet 201 is a display unit of the video wall 200. For example, when the video wall 200 is an LED display screen, each display cabinet 201 is one display unit of the LED display screen, each display cabinet 201 may include a display screen, a main control board, etc. When the video wall 200 is an LCD display screen, each display cabinet 201 is one display unit of the LCD display screen, each display cabinet 201 may include a display screen, a main control board, etc. It should be understood that the mounting bracket 100 can also be extended to mount one or more video walls 200, which is not limited here.

In at least one embodiment, each display cabinet 201 itself may also be a video wall formed by a plurality of sub-display units, which is not limited here.

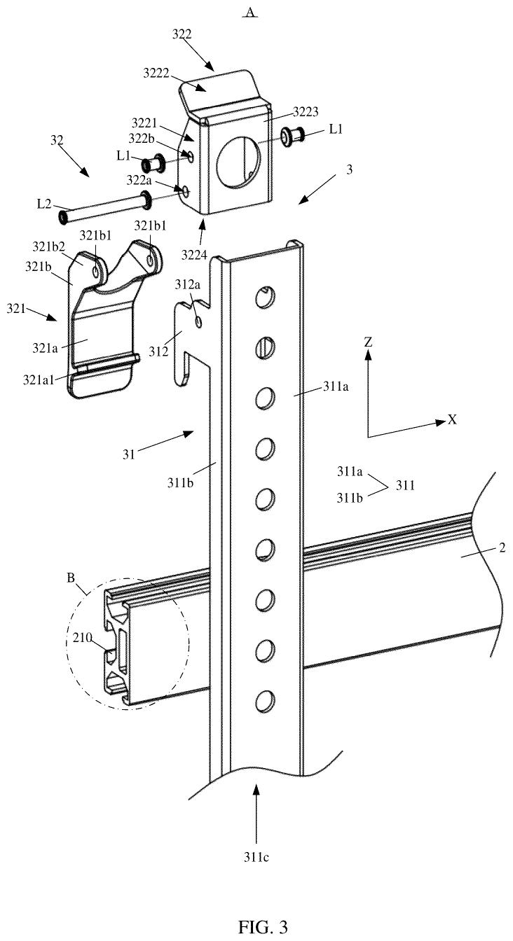

Please refer to FIG. 3. FIG. 3 is an exploded and enlarged view of A of FIG. 1. The mounting bracket 100 can include at least one first mounting member 2 and a plurality of hanging members 3. Each of the first mounting member 2 extends horizontally and defines a clamping groove 210. Each hanging member 3 can include a hanging rod 31 and a locking hook 32. The hanging rod 31 is configured to connect to back of one display cabinet 201 of the video wall 200 and is mounted on the first mounting member 2. The locking hook 32 is connected to the hanging rod 31. When the locking hook 32 engages with the clamping groove 210, the hanging member 3 is in a locked state. When the locking hook 32 disengages from the clamping groove 210, the hanging member 3 is in an unlocked state.

Therefore, the first mounting member 2 can be configured to form the mounting sub-region 101, each mounting sub-region 101 is configured to mount at least one hanging member 3, so as to mount one display cabinet 201, achieving the mounting of the display cabinet 201. Additionally, by suspending the display cabinet 201 to the first mounting member 2 via the hanging rod 31 and locking the hanging rod 31 to the first mounting member 2 through the engagement of the locking hook 32 with the clamping groove 210, a detachable connection is achieved, enabling quick mounting and convenient disassembly for maintenance.

In at least one embodiment, the first mounting member 2 extending horizontally means that the lengthwise extension direction of the first mounting member 2 is approximately parallel to the X-axis direction, including a state where the lengthwise extension direction of the first mounting member 2 is completely parallel to the X-axis direction or a state where the lengthwise extension direction of the first mounting member 2 forms an angle of less than a preset angle (e.g., 10 degrees) with the X-axis direction. It should be understood that, ideally, the lengthwise extension direction of the first mounting member 2 is completely parallel to the X-axis direction. However, in actual mounting, errors may occur. Therefore, when the lengthwise extension direction of the first mounting member 2 forms an angle with the X-axis direction, adjustments can be made using a horizontal adjustment mechanism, etc.

In at least one embodiment, different positions of the first mounting member 2 along the X-axis direction can be configured to mount different hanging members 3.

In at least one embodiment, the at least one first mounting member 2 may be one or more pieces. When the at least one first mounting member 2 is more pieces, a plurality of first mounting members 2 are arranged at intervals along the Z-axis direction. In this embodiment, the at least one first mounting member 2 may be four pieces, arranged along the Z-axis direction at interval. In other embodiments, the at least one first mounting members 2 may be but is not limited to four pieces and can be determined based on the size of the video wall 200.

As shown in FIG. 1, in the present disclosure, each first mounting member 2 can be configured to mount four hanging members 3. Every two hanging members 3 are configured to install one display cabinet 201. Since there are four first mounting members 2, a total of eight display cabinets 201 can be mounted. It should be understood that, in other embodiments, the length and quantity of the first mounting members 2 can be adjusted as needed.

In at least one embodiment, the first mounting member 2 is made of profile. On one hand, profile offers good structural stability and high dimensional accuracy. On the other hand, the clamping groove 210 on the profile can extend continuously along the lengthwise direction of the profile, facilitating adjustments to the position of the first mounting member 2 and the mounting position of the hanging member 3 on the first mounting member 2, which makes it easier to accommodate display cabinets 201 with different sizes.

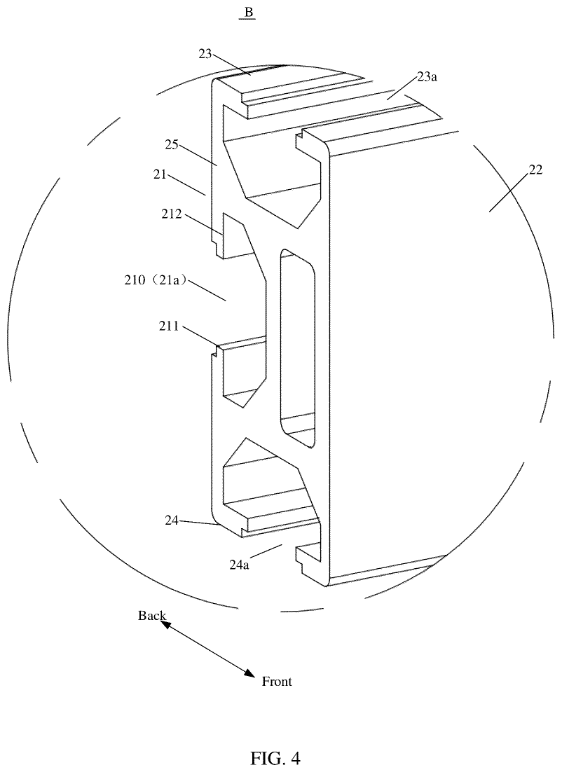

Please refer to FIG. 4. FIG. 4 is an enlarged view of B of FIG. 3. In at least one embodiment, the first mounting member 2 can include a first surface 21 and a second surface 22 opposite to each other, as well as a first side surface 23 and a second side surface 24 opposite to each other. The hanging rod 31 can include a hanging strip 311 and a hanging hook member 312. The hanging strip 311 is configured to connect to the back of the display cabinet 201, and the hanging hook member 312 is connected to one side of the hanging strip 311. The hanging rod 31 abuts against the second surface 22, and the clamping groove 210 is defined on the first surface 21.

Therefore, in the present disclosure, the clamping groove 210 is defined on the first surface 21 of the first mounting member 2, which faces away from the hanging strip 311, ensuring safer and more reliable locking with better load-bearing capacity.

In at least one embodiment, the first mounting member 2 can include a first end surface 25 and a second end surface (not shown) opposite to each other. The clamping groove 210 extends horizontally and penetrates continuously through the first end surface 25 and the second end surface.

Therefore, in the present disclosure, the clamping groove 210 extends continuously through the first end surface 25 and the second end surface horizontally, allowing the locking hook 32 to engage with the clamping groove 210 at any position along a horizontal direction, which facilitates adjusting the position of the display cabinet 201, so as to mount display cabinets 201 of different lengths. The length of the display cabinet 201 refers to a dimension of the display cabinet at X-axis direction. The horizontal direction is substantially parallel to the X-axis direction.

Please refer to FIG. 4. In at least one embodiment, the cross-section of the clamping groove 210 is C-shaped. A clamping opening 211 of the clamping groove 210 is located on the first surface 21 of the first mounting member 2. A height dimension of the clamping opening 211 on the first surface 21 is smaller than a height dimension inside the clamping groove 210. In other words, the height dimension of the clamping groove 210 varies at different positions from front to back. Therefore, the clamping groove 210 forms the clamping opening 211 and a clamping portion 212 located above the clamping opening 211. The hanging hook member 312 is mounted on a top surface (i.e., the first side surface 23) of the first mounting member 2. The locking hook 32 extends downward relative to the hanging hook member 312 and can enter interior of the clamping groove 210 through the clamping opening 211 to engage with the clamping portion 212 of the clamping groove 210.

Therefore, in the present disclosure, the cross-section of the clamping groove 210 is C-shaped, forming the clamping portion 212 on one side of the clamping opening 211, which ensures better engagement with the locking hook 32 and easier unlocking when needed, reducing the risk of jamming.

It should be understood that, in other embodiments, the clamping groove 210 is not limited to a C-shape and may take other forms.

In at least one embodiment, the locking hook 32 can include a locking hook member 321 and an actuating member 322. The actuating member 322 can include a first connection point 322a and a second connection point 322b. The second connection point 322b is located above the first connection point 322a. The first connection point 322a is pivotally connected to the hanging hook member 312. The second connection point 322b is pivotally connected to the locking hook member 321. When the actuating member 322 is in a first position, the locking hook member 321 engages with the clamping groove 210, and the hanging member 3 is in the locked state. The first position refers to a position where the actuating member 322 is substantially parallel to the hanging strip 311. When the actuating member 322 is in a second position, the locking hook member 321 disengages from the clamping groove 210, and the hanging member 3 is in the unlocked state. The second position refers to a position where the actuating member 322 is substantially inclined to the hanging strip 311.

Therefore, in the present disclosure, with the first connection point 322a as the pivot, the actuating member 322 can rotate the locking hook member 321 in two opposite directions to release or lock the locking hook member 321 in the clamping groove 210 of the first mounting member 2. Moreover, since the clamping groove 210 is located on the side of the first mounting member 2 facing the second mounting member 1, the actuating member 322 drives the locking hook member 321 to engage or disengage with the clamping groove 210, making operation more convenient. Additionally, the actuating member 322 is connected to the hanging hook member 312, resulting in a more compact structure and avoiding interference with the hanging strip 311.

In at least one embodiment, the actuating member 322 can include a first connecting wall 3221. The first connection point 322a and the second connection point 322b are located at different positions on the first connecting wall 3221. The locking hook member 321 can include a hook plate 321a and a connecting portion 321b. One end of the connecting portion 321b is connected to one end of the hook plate 321a, and the other end of the connecting portion 321b is connected to the second connection point 322b of the actuating member 322. One side of the hook plate 321a facing the first mounting member 2 can include a locking block 321a1, which is configured to engage with the clamping groove 210.

Therefore, in the present disclosure, the first connection point 322a and the second connection point 322b are located at different positions of the first connecting wall 3221. One end of the connecting portion 321b is connected to one end of the hook plate 321a, and the other end of the connecting portion 321b is connected to the second connection point 322b of the actuating member 322. The locking block 321a1 is configured to engage with the clamping groove 210, ensuring a compact and stable connection.

In at least one embodiment, the angle between the locking block 321a1 and the hook plate 321a is acute, and the angle between the locking block 321a1 and the hook plate 321a faces the connecting portion 321b.

Therefore, in the present disclosure, pushing the actuating member 322 backward can disengage the locking hook member 321 from the clamping groove 210, while pulling it forward can lock the locking hook member 321 into the clamping groove 210, ensuring a simple and reliable structure.

In at least one embodiment, the actuating member 322 can further include an actuating portion 3222; the actuating portion 3222 is connected to a top end of the first connecting wall 3221. The actuating portion 3222 protrudes out from the top end of the hanging rod 31.

Therefore, in the present disclosure, the actuating portion 3222 protrudes out from the top end of the hanging rod 31, making the actuating member 322 easy to operate.

In at least one embodiment, the hanging strip 311 and the hanging hook member 312 are integrally formed, enhancing a structural strength of the hanging rod 31. In other embodiments, the hanging strip 311 and the hanging hook member 312 may be welded or connected in other ways, which is not limited here.

In at least one embodiment, the actuating member 322 can further include a first main body 3223. The first connecting wall 3221 may be two pieces. The two first connecting walls 3221 are connected to opposite sides of the first main body 3223 respectively to form a first U-shaped structure 3224. The actuating portion 3222 is connected to a top end of the first U-shaped structure 3224. The hanging strip 311 can include a second main body 311a and two second connecting walls 311b. The two second connecting walls 311b are connected to opposite sides of the second main body 311a respectively to form a second U-shaped structure 311c. The first U-shaped structure 3224 is embedded inside the second U-shaped structure 311c, and the actuating portion 3222 protrudes out from a top end of the second U-shaped structure 311c. The hanging hook member 312 is connected to the second connecting wall 311b.

Therefore, in the present disclosure, the actuating member 322 is embedded inside the hanging strip 311, resulting in a compact structure that allows the mounting bracket 100 to be thinner.

In at least one embodiment, the first connection point 322a and the second connection point 322b are each defined with a through-hole. The connecting portion 321b is defined with a first connecting hole 321b1, and the first connecting hole 321b1 and the through hole of the second connection point 322b are rotatably connected via a first connecting member L1. As shown in FIG. 3, one side of the connecting portion 321b facing the actuating member 322 is defined with a U-shaped groove, so the connecting portion 321b has two connecting arms 321b2. Each connecting arm 321b2 is defined with a first connecting hole 321b1. The first connecting member L1 passes through the first connecting hole 321b1 and the through-hole of the second connection point 322b, rotatably connecting the second connection point 322b of the actuating member 322 to the connecting portion 321b of the locking hook member 321. The hanging hook member 312 is defined with a second connecting hole 312a, and the through hole of the second connection point 322b and the second connecting hole 312a are rotatably connected via a second connecting member L2. It should be understood that the first connecting member L1 and the second connecting member L2 may be, but are not limited to, rivets, etc.

Therefore, in the present disclosure, the U-shaped groove provides clearance for user operation of the actuating portion 3222, and the rivet connection is simple, safe, and reliable.

It should be understood that, in other embodiments, the locking hook member 321 and the actuating member 322 are not limited to the above structure and may adopt other linkage mechanisms, which are not limited here.

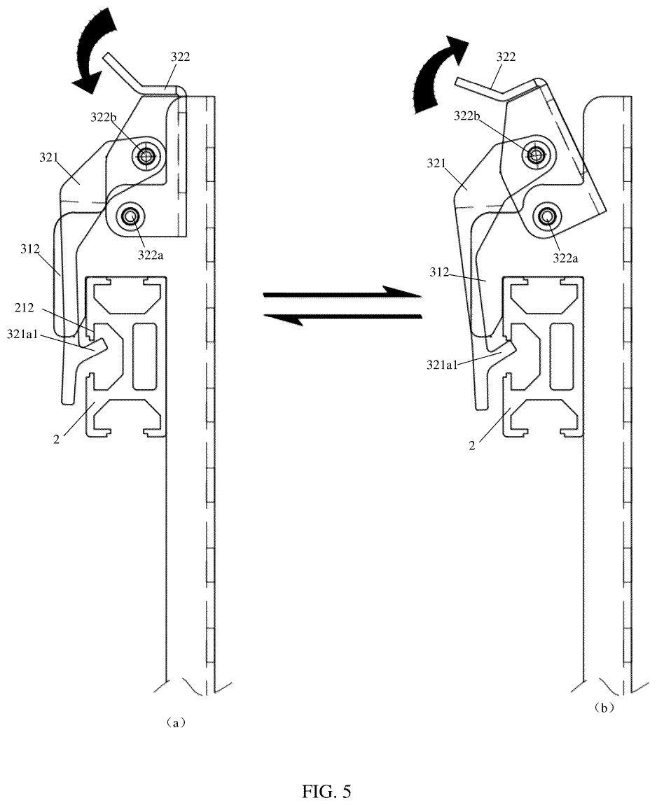

Please refer to FIG. 5. FIG. 5 is a schematic view of a mounting state of a hanging member and a first mounting member. In FIG. 5(a), the hanging member 3 is locked to the first mounting member 2, while in FIG. 5(b), the hanging member 3 is in an unlocked state and can be separated from the first mounting member 2.

As shown in FIG. 5(a), when the hanging member 3 is in the locked state, the actuating member 322 is in the first position, meaning the first main body 3223 of the actuating member 322 is parallel to the second main body 311a of the hanging strip 311. As shown in FIG. 5(b), when the locking hook member 321 disengages from the clamping groove 210, the actuating member 322 is in the second position, the hanging member 3 is in the unlocked state, meaning the first main body 3223 of the actuating member 322 is inclined relative to the second main body 311a of the hanging strip 311, and the locking block 321a1 of the locking hook member 321 is separated from the clamping portion 212.

In the state shown in FIG. 5(a), operating the actuating member 322 in the direction indicated by the arrow in FIG. 5(a) will switch the actuating member 322 to the state shown in FIG. 5(b), transitioning from the locked state to the unlocked state. Conversely, in the state shown in FIG. 5(b), operating the actuating member 322 in the direction indicated by the arrow in FIG. 5(b) will switch the actuating member 322 to the state shown in FIG. 5(a), transitioning from the unlocked state to the locked state.

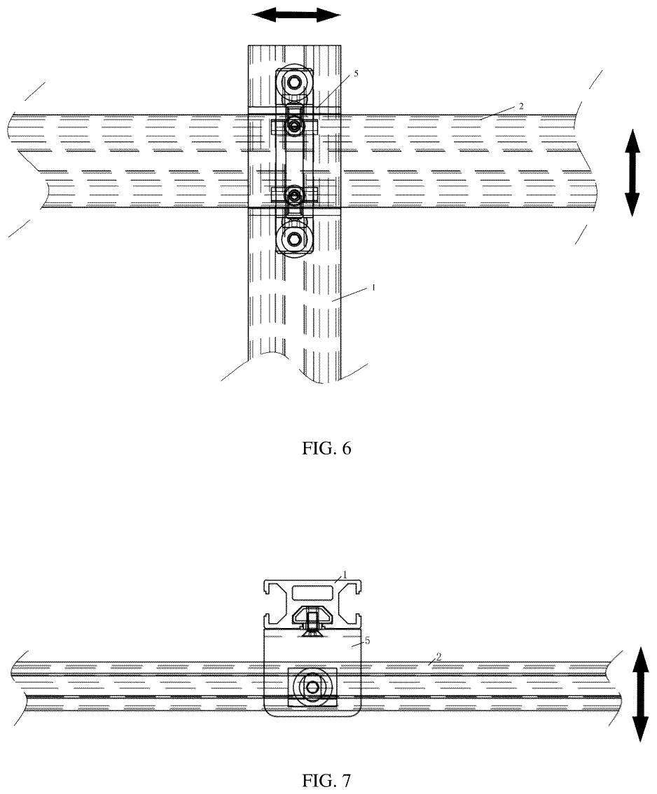

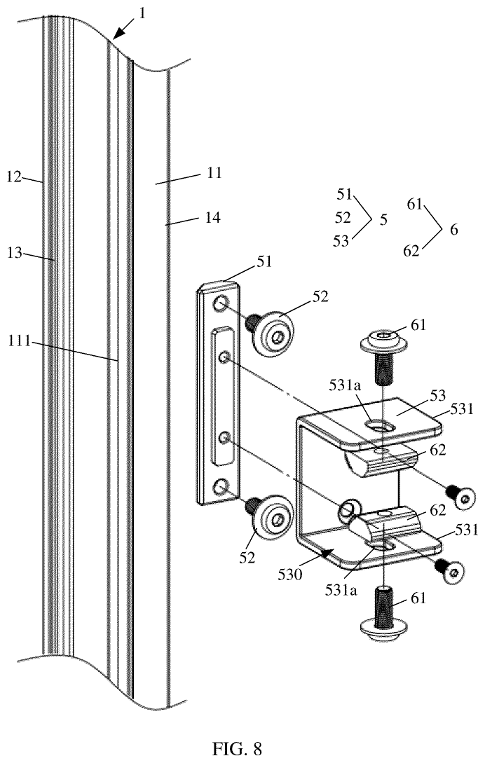

Please refer to FIGS. 6, 7, and 8. FIG. 6 is an enlarged front view of B in FIG. 1. FIG. 7 is a top view of FIG. 6. FIG. 8 is an exploded view of FIG. 6.

In at least one embodiment, the mounting bracket 100 can further include at least one second mounting member 1. The at least one second mounting member 1 is configured to mount on a wall. The at least one first mounting member 2 is cross-connected to one side of the at least one second mounting member 1 back from the wall. The mounting bracket 100 can also include at least one first adjustment member 5. Each of the first adjustment member 5 is connected between the first mounting member 2 and the second mounting member 1. The first adjustment member 5 adjusts the position of the first mounting member 2 relative to the second mounting member 1 in a vertical direction. The vertical direction refers to a direction parallel to the Z-axis direction or forming an angle of less than a preset angle with the Z-axis direction.

Therefore, in the present disclosure, by using the second mounting member 1, on one hand, the second mounting member 1 serves to connect to the wall, on the other hand, the first adjustment member 5 is located between the first mounting member 2 and the second mounting member 1. This allows adjustment of the vertical position of the first mounting member 2 relative to the second mounting member 1, making it compatible with display cabinets 201 of different height dimensions.

In at least one embodiment, a lengthwise extension direction of the second mounting member 1 is parallel to the Z-axis direction. In other embodiments, a lengthwise extension direction of the second mounting member 1 may form an angle of less than a preset angle with the Z-axis direction, meaning it is approximately parallel to the Z-axis direction.

In at least one embodiment, the at least one second mounting member 1 may be one or more pieces. If the second mounting member 1 is wide enough to provide sufficient contact area with the first mounting member 2, the second mounting member 1 may be a single piece. In other embodiments, the second mounting member 1 may be two or more pieces arranged along the X-axis direction at interval, providing stable support for the mounting of the first mounting member 2. In this embodiment, the second mounting member 1 may be two pieces arranged along the X-axis direction at interval, ensuring stable support for the mounting of the first mounting member 2.

In at least one embodiment, the two second mounting members 1 are arranged in parallel. In other embodiments, the two second mounting members 1 may not be parallel, which is not limited here.

In at least one embodiment, the second mounting member 1 is profile, offering good structural stability and high dimensional accuracy.

In at least one embodiment, as shown in FIG. 8, the second mounting member 1 can include a third surface 11 and a fourth surface 12 opposite to each other, as well as a third side surface 13 and a fourth side surface 14 opposite to each other, and a third end surface and a fourth end surface opposite to each other. The third surface 11 is defined with a first sliding groove 111, which extends along the vertical direction. The vertical direction is parallel to a lengthwise direction of the second mounting member 1. Each first adjustment member 5 can include a first sliding block 51, at least one first locking member 52, and a first adapter 53. The first sliding block 51 is slidably connected in the first sliding groove 111. The first locking member 52 is configured to lock the first sliding block 51 at a preset position in the first sliding groove 111. The first adapter 53 is connected to the first sliding block 51. The first mounting member 2 is connected to an opening 530 of the first adapter 53.

Therefore, in the present disclosure, the first sliding block 51, the first locking member 52, and the first adapter 53 cooperatively enable the first mounting member 2 to be slidably connected in the first sliding groove 111 of the second mounting member 1, allowing adjustment of the vertical position of the first mounting member 2. This, in turn, allows adjustment of the vertical position of the display cabinet 201, making it compatible with display cabinets 201 of different heights.

In at least one embodiment, the first sliding groove 111 extending along the vertical direction means that the lengthwise extension direction of the first sliding groove 111 is approximately parallel to the Z-axis direction, including a state where the lengthwise extension direction is completely parallel to the Z-axis direction or a state where the lengthwise extension direction forms an angle of less than a preset angle (e.g., 10 degrees) with the Z-axis direction.

In at least one embodiment, when adjusting the position of the first sliding block 51 in the first sliding groove 111, loosening the first locking member 52 allows the first sliding block 51 to slide in the first sliding groove 111. Once the first sliding block 51 reaches the desired position, tightening the first locking member 52 again completes the adjustment. This simple adjustment method accommodates display cabinets 201 with different height dimensions.

In at least one embodiment, the first sliding block 51 and the first sliding groove 111 have matching shapes. The first sliding groove 111 is C-shaped. The first sliding block 51 is also a C-shaped strip. Therefore, part of the first sliding block 51 can be embedded inside the first sliding groove 111, and another part of the first sliding block 51 can protrude from an opening of the first sliding groove 111 on the third surface 11. The threaded holes on the first sliding block 51 are defined on the another part of the first sliding block 51. The first locking member 52 is threaded into the threaded hole of the first sliding block 51 and extends through the threaded hole to abut against the bottom surface of the first sliding groove 111. By rotating the first locking member 52, the friction force between the first locking member 52 and the bottom surface of the first sliding groove 111 can be adjusted. When the friction force is low, the first sliding block 51 can slide relative to the bottom surface of the first sliding groove 111 under external force. Conversely, when the friction force is high, the first sliding block 51 remains stationary relative to the bottom surface of the first sliding groove 111.

It should be understood that, in other embodiments, the first sliding groove 111 and the first sliding block 51 may take other shapes, which are not limited here.

In at least one embodiment, the two first locking members 52 and the one first adapter 53 are arranged on one side of the first sliding block 51 in an order of one first locking member 52, the first adapter 53, and another first locking member 52.

Therefore, in the present disclosure, the first adjustment member 5 has a more compact structure, contributing to a thinner design.

In at least one embodiment, the mounting bracket 100 can further include at least one second adjustment member 6. Each second adjustment member 6 is connected between the corresponding first adjustment member 5 and the corresponding first mounting member 2. The second adjustment member 6 adjusts the position of the first mounting member 2 in the front-rear direction. Here, the front-rear direction refers to a direction parallel to the Y-axis direction.

Therefore, in the present disclosure, the second adjustment member 6 allows adjustment of the front-rear position of the first mounting member 2, ensuring that the display surfaces of different display cabinets 201 mounted on the first mounting member 2 are coplanar.

In at least one embodiment, the first adapter 53 can include at least one connecting arm 531. Each connecting arm 531 is defined with an elongated hole 531a. The lengthwise direction of the elongated hole 531a extends along a front-rear direction. Each second adjustment member 6 can include at least one abutting block 61 and at least one second locking member 62. Each abutting block 61 is located on one connecting arm 531 of the first adapter 53 and abuts against the connecting arm 531 of the first adapter 53. Each second locking member 62 passes through one elongated hole 531a and connects to the corresponding abutting block 61. When the second locking member 62 is locked at different positions in the elongated hole 531a, the first mounting member 2 is correspondingly locked at different positions within the first adapter 53 in the front-rear direction.

When adjusting the front-rear position of the first mounting member 2, loosening the second locking member 62 allows manual adjustment of the front-rear position of the first mounting member 2 within the first adapter 53. Tightening the second locking member 62 again completes the adjustment.

Therefore, in the present disclosure, the elongated hole 531a on the connecting arm 531 of the first adapter 53, along with the abutting block 61 and the second locking member 62, enables adjustment of the front-rear position of the first mounting member 2, which ensures that the display surfaces of different display cabinets 201 mounted on the first mounting member 2 are coplanar, accommodating display cabinets 201 of different thicknesses. The structure is simple, easy to operate, and cost-effective.

In at least one embodiment, the first adapter 53 is U-shaped. The at least one connecting arm 531 may be two pieces. The two connecting arms 531 are arranged in the vertical direction. The abutting block 61 and the second locking member 62 are each provided in two. The two abutting blocks 61 are respectively located on the inner surfaces of the two connecting arms 531. The two second locking members 62 respectively pass through the two elongated holes 531a from the outer surfaces of the two connecting arms 531 and connect to the two abutting blocks 61.

Therefore, the connection stability of the first adapter 53 is improved.

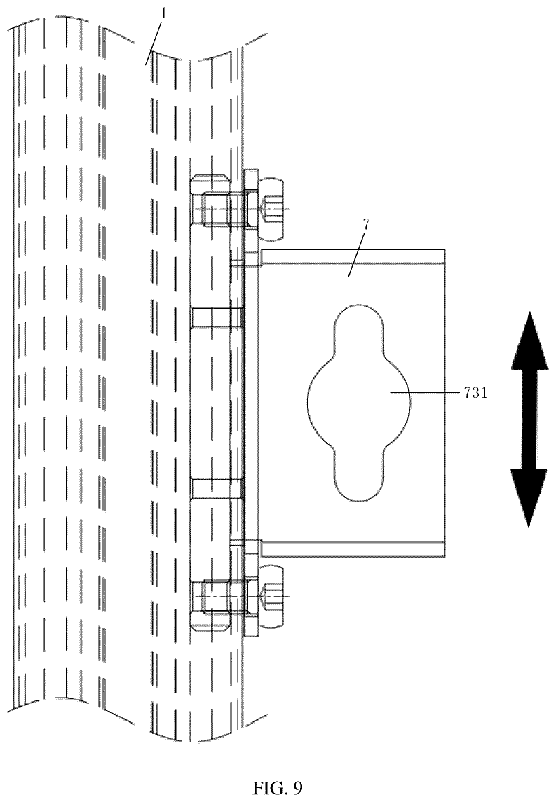

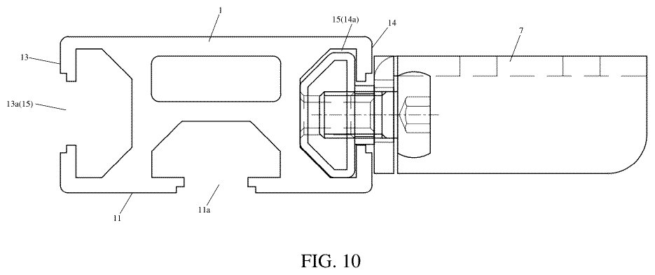

In at least one embodiment, please refer to FIGS. 9, 10, and 11. The third side surface 13 or the fourth side surface 14 is defined with a second sliding groove 15. The second sliding groove 15 extends along the vertical direction. The mounting bracket 100 can further include at least one third adjustment member 7. One side of the third adjustment member 7 is slidably connected to the second sliding groove 15, and the other side of the third adjustment member 7 is fixed to the wall. The third adjustment member 7 is configured to adjust the position of the second mounting member 1 in the horizontal direction and/or in the vertical direction.

Therefore, in the present disclosure, the third adjustment member 7 enables adjustment of the horizontal and/or vertical position of the second mounting member 1. After drilling mounting holes on the wall, the position of the third adjustment member 7 relative to the mounting holes can be adjusted to ensure accurate mounting of the second mounting member 1. The third adjustment member 7 also allows selection of drilling positions within a certain range in the horizontal and/or vertical direction, ensuring that the mounting holes can be drilled into load-bearing wooden studs. This makes it more suitable for wooden stud walls.

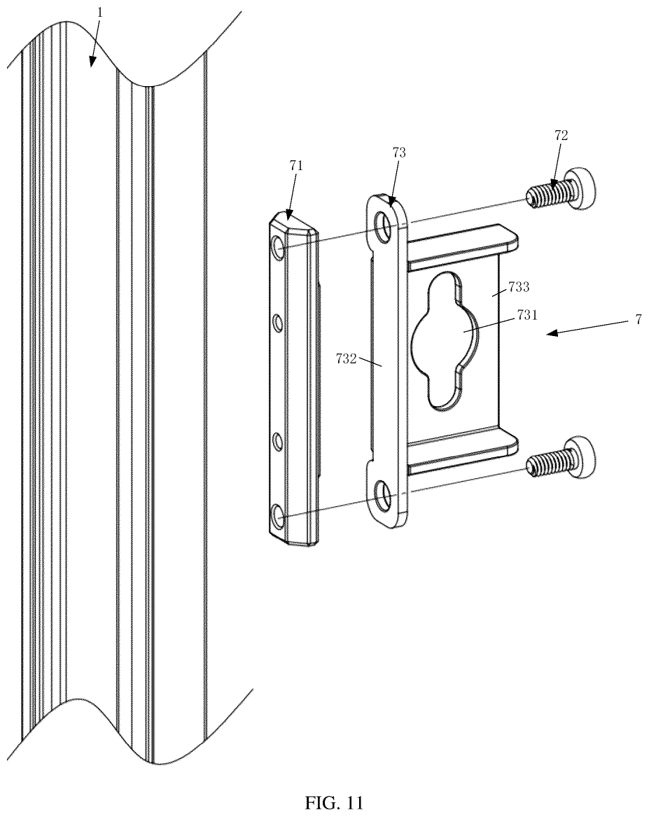

In at least one embodiment, as shown in FIG. 11, the third adjustment member 7 can include a second sliding block 71, at least one third locking member 72, and a second adapter 73. The second sliding block 71 is slidably connected in the second sliding groove 15. The third locking member 72 locks the second sliding block 71 at a preset position in the second sliding groove 15. One side of the second adapter 73 is connected to the second sliding block 71, and the other side of the second adapter 73 is defined with an adjustment hole 731. When a fourth locking member is locked at different positions in the adjustment hole 731, the second mounting member 1 can be positioned at different horizontal and/or vertical positions.

Therefore, in the present disclosure, the adjustment hole 731, due to its structure, allows the fourth locking member mounted in the adjustment hole 731 to move within a certain range in the horizontal and/or vertical positions, which facilitates adjustment of the position of the second mounting member 1 and ensures that mounting holes can be drilled into load-bearing wooden studs, making it more suitable for wooden stud walls.

In at least one embodiment, as shown in FIG. 11, the second sliding block 71 and the second sliding groove 15 have matching shapes. The second sliding groove 15 is C-shaped, and the second sliding block 71 is also a C-shaped strip. Therefore, part of the second sliding block 71 can be embedded inside the second sliding groove 15, and another part of the second sliding block 71 can protrude from the opening of the second sliding groove 15 on the fourth side surface 14. The threaded hole on the second sliding block 71 is defined on the another part of the second sliding block 71. The third locking member 72 is threaded into the threaded hole of the second sliding block 71 and extends through the threaded hole to abut against the bottom surface of the second sliding groove 15. By rotating the third locking member 72, the friction force between the third locking member 72 and the bottom surface of the second sliding groove 15 can be adjusted. When the friction force is low, the second sliding block 71 can slide relative to the bottom surface of the second sliding groove 15 under external force. Conversely, when the friction force is high, the second sliding block 71 remains stationary relative to the bottom surface of the second sliding groove 15.

In at least one embodiment, the second adapter 73 can include a first connecting portion 732 and a second connecting portion 733. The first connecting portion 732 and the second connecting portion 733 are connected in an L-shape. The adjustment hole 731 is cross-shaped and defined on the second connecting portion 733, enabling adjustment in both the horizontal and vertical directions. Furthermore, the second connecting portion 733 is U-shaped, enhancing structural strength.

In other embodiments, the second adapter 73 can be but is not limited to an L-shape, and the adjustment hole 731 can be but is not limited to a cross shape.

In at least one embodiment, please refer to FIG. 4. The second mounting member 1 and the first mounting member 2 have the same structure. The first mounting member 2 defines a first through groove 21a on the first surface 21, a second through groove 23a on the first side surface 23, and a third through groove 24a on the second side surface 24. The first through groove 21a is the clamping groove 210. Please refer to FIG. 10. The second mounting member 1 defines a fourth through groove 11a on the third surface 11, a fifth through groove 13a on the third side surface 13, and a sixth through groove 14a on the fourth side surface 14. The fourth through groove 11a is the first sliding groove 111, and the fifth through groove 13a or the sixth through groove 14a is the second sliding groove 15. The first through groove 21a corresponds to the fourth through groove 11a, the second through groove 23a corresponds to the fifth through groove 13a, and the third through groove 24a corresponds to the sixth through groove 14a.

Therefore, in the present disclosure, the second mounting member 1 and the first mounting member 2 have the same structure, ensuring interchangeability for easier production and assembly.

In at least one embodiment, the second mounting member 1 and/or the first mounting member 2 are profiles.

Therefore, in the present disclosure, the second mounting member 1 and/or the first mounting member 2 being profiles facilitates processing and ensures good structural stability and high strength. Additionally, by using profiles of different lengths or combining profiles, the mounting of the plurality of display cabinets 201 can be achieved, allowing infinite expansion and providing consumers with more options.

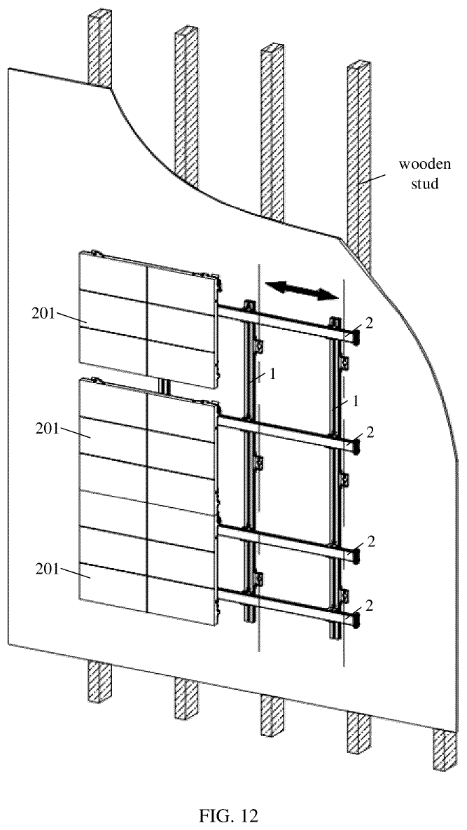

Please refer to FIG. 12. For wooden stud walls, the spacing between adjacent first mounting members 2 can be adjusted by changing the position of the third locking member 72 in the adjustment hole 731. This ensures that the third locking member 72 can be securely locked to the wooden studs, improving the load-bearing capacity of the mounting bracket 100.

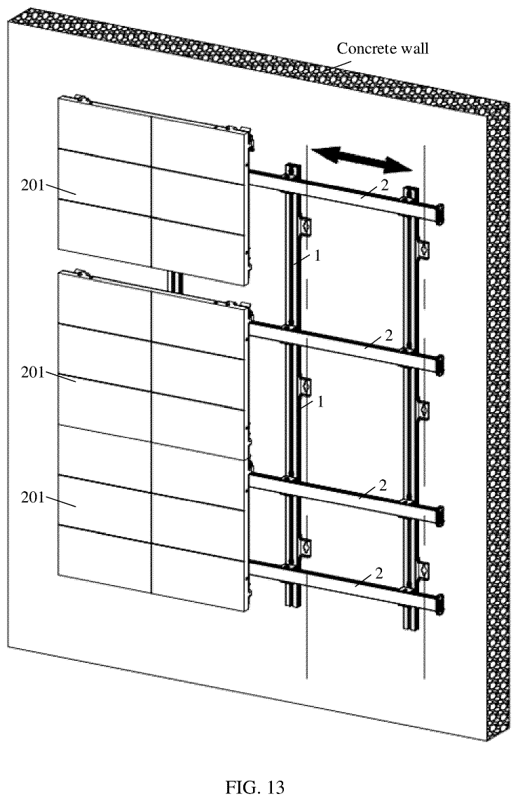

Please refer to FIG. 13. For concrete walls, the spacing between adjacent first mounting members 2 and the vertical alignment of each first mounting member 2 can also be adjusted by changing the position of the third locking member 72 in the adjustment hole 731.

Therefore, the mounting bracket 100 in the present disclosure can adapt to different types of walls, providing consumers with more mounting options.

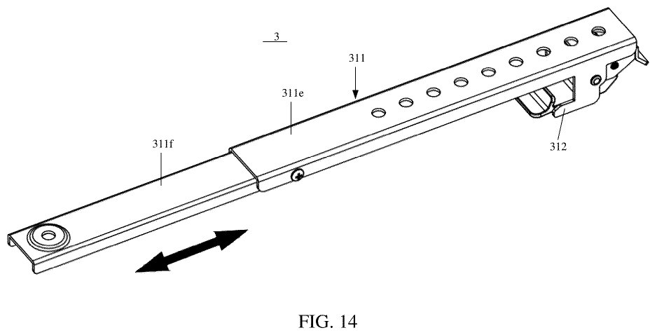

Please refer to FIG. 14. The length of the hanging member 3 is adjustable. Specifically, the length of the hanging strip 311 of the hanging member 3 can be extended, such as through threaded connections. The hanging strip 311 can include a first hanging portion 311e and a second hanging portion 311f. The hanging hook member 312 is located on the first hanging portion 311e. The first hanging portion 311e and the second hanging portion 311f are detachably connected, and a total length after connection can be adjusted and is greater than a length of the first hanging portion 311e.

Therefore, in the present disclosure, the total length of the hanging strip 311 is adjustable, accommodating display cabinets 201 of different height dimensions.

The above describes the technical solutions and details of the present disclosure. It is understandable that the above description only covers some embodiments of the technical solutions, and some details may be omitted during actual implementation.

Additionally, in at least one embodiment of the present disclosure, multiple embodiments may be combined in practice. Due to space limitations, not all combinations are listed here. Those of ordinary skill in the art can freely combine the above embodiments based on requirements to achieve better application performance.

In conclusion, the present disclosure possesses the aforementioned advantageous features, enabling it to deliver unprecedented performance in practical use, making it a highly practical and valuable product.

The above descriptions are merely preferred embodiments of the present disclosure and are not intended to limit the scope of the application. Any modifications, equivalent substitutions, or improvements made within the spirit and principles of the application shall be included within the protection scope of the application.

What is claimed is:

1. A mounting bracket for video wall, wherein the mounting bracket comprises at least one first mounting member and a plurality of hanging members; each of the first mounting member extends horizontally and defines a clamping groove; each of the hanging member comprises a hanging rod and a locking hook; the hanging rod is configured for connecting to a display cabinet of a video wall and suspending the display cabinet to the corresponding first mounting member, and the locking hook is connected to the hanging rod; when the locking hook is engaged with the clamping groove, the hanging member is located in a locked state; and when the locking hook is disengaged from the clamping groove, the hanging member is in an unlocked state.

2. The mounting bracket according to claim 1, wherein the first mounting member comprises a first surface and a second surface opposite to the first surface;
the hanging rod comprises a hanging strip and a hook member, the hanging strip is configured for connecting to the display cabinet, and the hook member is connected to one side of the hanging strip; and
the hanging strip abuts the second surface; the clamping groove is defined on the first surface.

3. The mounting bracket according to claim 2, wherein: the first mounting member comprises a first end surface and a second end surface opposite to the first end surface; and the clamping groove extends horizontally through the first end surface and the second end surface.

4. The mounting bracket according to claim 2, wherein: the clamping groove has a C-shaped cross section; a clamping opening of the clamping groove is defined on the first surface;
the clamping groove forms a clamping portion on one side of the clamping opening; and the locking hook is capable of enter interior of the clamping groove through the clamping opening and engage with the clamping portion.

5. The mounting bracket according to claim 3, wherein: the clamping groove has a C-shaped cross section; a clamping opening of the clamping groove is defined on the first surface;
the clamping groove forms a clamping portion on one side of the clamping opening; and the locking hook is capable of enter interior of the clamping groove through the clamping opening and engage with the clamping portion.

6. The mounting bracket according to claim 2, wherein: the locking hook comprises a locking hook member and an actuating member; the actuating member comprises a first connection point and a second connection point; the second connection point is located above the first connection point; the first connection point is pivotally connected to the hanging hook member, and the second connection point is pivotally connected to the locking hook member;
when the actuating member is located in a first position, the hook member is engaged with the clamping groove, the hanging member is in the locked state; and when the actuating member is in a second position, the hook member is disengaged from the clamping groove, the hanging member is in the unlocked state.

7. The mounting bracket according to claim 6, wherein: the actuating member comprises at least one first connecting wall, the first connection point and the second connection point are positioned at different positions of each of the first connecting wall; the hook member comprises a hook plate and a connecting portion, where one end of the connecting portion is connected to one end of the hook plate and the other end of the connecting portion is pivotally connected to the second connection point of the actuating member; and one side of the hook plate facing towards the first mounting member comprises a locking block, the locking block is configured for engaging with the clamping groove.

8. The mounting bracket according to claim 7, wherein: an angle between the locking block and the hook plate is acute; and a clamping opening of the angle between the locking block and the hook plate faces towards the connecting portion.

9. The mounting bracket according to claim 7, wherein: the actuating member further comprises an actuating portion; the actuating portion is connected to a top end of the first connecting wall; and the actuating portion protrudes outward from the top end of the hanging strip.

10. The mounting bracket according to claim 9, wherein: the actuating member also comprises a first main body, the at least one first connecting wall comprises two first connecting walls, the two first connecting walls are connected to opposite sides of the first main body to form a first U-shaped structure; the actuating portion is connected to a top end of the first U-shaped structure; the hanging strip comprises a second main body and two second connecting walls; the two second connecting walls are connected to the two second connecting walls of the second main body to form a second U-shaped structure; the first U-shaped structure is embedded within the second U-shaped structure; the actuating portion protrudes outward from a top end of the second U-shaped structure; and the hook member is connected to the second connecting wall.

11. The mounting bracket according to claim 1, wherein: the mounting bracket further comprises at least one second mounting member; the at least one second mounting member is configured for mounting on a wall; the at least one first mounting member is cross-connected to one side of the at least one second mounting member opposite to the wall; the mounting bracket further comprises at least one first adjustment member; each of the at least one first adjustment member is connected between the corresponding first mounting member and the corresponding second mounting member; and the first adjustment member is configured to adjust a position of the corresponding first mounting member relative to the corresponding second mounting member in a vertical direction.

12. The mounting bracket according to claim 11, wherein: the second mounting member comprises a third surface and a fourth surface opposite to the third surface;
the second mounting member defines a first sliding groove on the third surface, the first sliding groove extends along the vertical direction;
the first adjustment member comprises a first sliding block, at least one first locking member, and a first adapter; the sliding block is slidably connected in the first sliding groove; the first locking member is configured for locking the first sliding block at a predefined position of the first sliding groove; and the first adapter is configured to connect between the first sliding block and the corresponding first mounting member.

13. The mounting bracket according to claim 12, wherein: the mounting bracket further comprises at least one second adjustment member; each of the second adjustment member is connected between the first adjustment member and the corresponding first mounting member; and the second adjustment member is configured for adjusting a position of the first mounting member in a front-back direction of the mounting bracket.

14. The mounting bracket according to claim 13, wherein: the first adapter comprises at least one connecting arm; each of the at least one connecting arm defines an elongated hole extending along the front-back direction; the second adjustment member comprises at least one abutment block and at least one second locking member, the abutment block is located in a surface of the corresponding connecting arm facing the first mounting member, the abutment block is configured to abut against the first mounting member; and when the second locking member penetrates through the elongated hole to secure the abutment block at different positions of the elongated hole, the first mounting member is locked at different positions of the first adapter.

15. The mounting bracket according to claim 12, wherein: the second mounting member comprises a third side surface and a fourth side surface opposite to the third side surface;
a second sliding groove is defined on the third side surface or the fourth side surface and extends in the vertical direction;
the mounting bracket comprises at least one third adjustment member, one side of the third adjustment member is slidably connected in the second sliding groove, the other side of the third adjustment member is configured to be fixed to the wall; and
the third adjustment member is configured to adjust the position of the second mounting member in a horizontal and/or the vertical direction.

16. The mounting bracket according to claim 15, wherein: the third adjustment member comprises a second sliding block, at least one third locking member, and a second adapter; the second sliding block is slidably connected in the second sliding groove; the third locking member is configured to secure the sliding block at preset positions within the second sliding groove; one side of the second adapter is connected to the second sliding block, and the other side of the second adapter defines an adjustment hole; and when a fourth locking member is engaged at different positions of the adjustment hole, the second mounting member can be fixed at different horizontal and/or vertical positions.

17. The mounting bracket according to claim 15, wherein: the first mounting member and the second mounting member have same structures; the first mounting member comprises a first surface and a second surface opposite to the first surface, as well as a first side surface and a second side surface opposite to the first side surface; the first surface defines a first through slot, the first side surface defines a second through slot, and the second side surface defines a third through slot; the first through slot is the clamping groove;
the second mounting member defines a fourth through slot on the third surface, a fifth through slot on the third side surface, and a sixth through slot on the fourth side surface, the fourth through slot is the first sliding groove, the fifth through slot or the sixth through slot is the second sliding groove; and
the first through slot corresponds to the fourth through slot, the second through slot corresponds to the fifth through slot, and the third through slot corresponds to the sixth through slot.

18. The mounting bracket according to claim 17, wherein the second mounting member and/or the first mounting member are profiles.

19. The mounting bracket according to claim 2, wherein: the hanging strip comprises a first strip portion and a second strip portion; the first strip portion and the second strip portion are detachably connected; and a total length of the first strip portion and the second strip portion is capable of being adjusted, and exceeds a length of the first strip portion.
